(19) United States
(12) Patent Application Publication
(10) Pub. No.: US 2012/0082865 A1
(43) Pub. Date: Apr. 5, 2012

(54) METHOD FOR FORMING A MAGNETIC RECORDING MEDIUM AND A MAGNETIC RECORDING MEDIUM FORMED THEREOF

(75) Inventors: Jie DENG, Singapore (SG); Yunjie CHEN, Singapore (SG); Jianzhong SHI, Singapore (SG); Baoyu ZONG, (US); Tianli HUANG, Singapore (SG); Siang Huei LEONG, Singapore (SG)

(73) Assignee: AGENCY FOR SCIENCE, TECHNOLOGY AND RESEARCH, Singapore (SG)

(21) Appl. No.: 13/249,775

(22) Filed: Sep. 30, 2011

(30) Foreign Application Priority Data
Oct. 1, 2010 (SG) 201007230-4

(51) Int. Cl. G11B 5/66; G11B 5/62; G11B 5/855

(52) U.S. Cl. 428/827; 427/131; 427/130; 428/826; 428/836; 428/831; 428/834

(57) ABSTRACT

A method for forming magnetic media is provided. The method of forming the magnetic media includes forming a plurality of regions of resist material on a top surface of a substrate which defines a plurality of regions of exposed substrate on the top surface of the substrate between adjacent ones of the plurality of regions of resist material. The method also includes forming magnetic material on the plurality of regions of resist material and the plurality of regions of exposed substrate and depositing material over the magnetic material, the material encapsulating a portion of the magnetic material formed on the plurality of regions of exposed substrate. A magnetic recording medium formed in accordance with the method is also provided.

### CROSS-REFERENCE TO RELATED APPLICATION

The present application claims priority, pursuant to 35 U.S.C. §119, to Singapore Patent Application No. 201007230-4, filed Oct. 1, 2010.

### FIELD OF INVENTION

The present invention relates to a magnetic recording medium and a method for forming the magnetic recording medium. More particularly, the present invention relates to a magnetic recording medium having regions of a magnetic material on a medium surface and the method for forming the regions on the medium surface.

### BACKGROUND TO THE INVENTION

Hard Disk Drives (HDD) are commonly used in electronic devices to provide a memory to store data for operation of the devices. In a HDD, data is stored on a magnetic media. As electronic devices evolve, there is a need to reduce the size of the magnetic media and/or to increase the amount of data that may be stored on the media. To reduce the size and/or increase the amount of data stored, the recording density of the media must be increased.

The current magnetic media for HDD are commonly a granular media that is produced by sputter deposition of an alloy onto a disk platter. Thus, the media is a granular media consisting of weakly coupled magnetic grains that are approximately 7-9 nm in size. Granular media of this size provides a recording density of approximately 0.5 Tbits/in.² where a single bit of information is stored over an area on the order of tens of these grains. In this type of media the only way to increase recording density is to reduce the number of grains per bit or the grain size. However, the number of grains per bit is limited by the signal to noise ratio requirements for data retrieval and the minimum grain size is limited by a superparamagnetic limit below which thermal instability of the magnetization state occurs. As such, the limit density of this granular media is approximately 1-1.5 Tbits/in.² Accordingly, those skilled in the art are constantly striving to produce better types of magnetic media that will provide greater recording densities.

One such type of magnetic recording media that may yield greater recording densities is a Bit Patterned Media (BPM). BPM has ordered arrays of magnetic bits. The ordered arrays are commonly formed using lithography. The lithographically ordered arrays of magnetic material significantly improve the signal to noise ratio. Thus, a single switchable volume per bit is sufficient for data retrieval and each bit is far from the superparamagnetic limit.

Two proposed methods for forming BPMs are illustrated in FIGS. 1A-C and 2A-C. The first method for producing BPM 100 begins, as shown in FIG. 1A, with magnetic film 120 being layered over a top surface of substrate 110. Resists 132 and 133 are formed on the top surface of magnetic film 120. As shown in FIG. 1B, ion milling is then applied to BPM 100 to remove material from magnetic film 120 that is exposed and not covered by resists 132 and 133. In this manner, magnetic islands 122 and 123 are formed from the material of magnetic film 120. A residual removal process is then applied to BPM 100 to remove resists 132 and 133 leaving only magnetic islands 122 and 123 on the top surface of substrate 110.

The second method forms BPM 200 as shown in FIGS. 2A-2C. The second method begins, as shown in FIG. 2A, by forming resists 222 and 223 on the top surface of substrate 210. As shown in FIG. 2B, a layer of magnetic material is applied over the exposed top surface of substrate 210 and resists 232, 233 to form magnetic islands 232-234 and magnetic resist islands 236-237. A process is then applied to remove resist 222 and 223. This results in resist magnetic islands 236 and 237 falling away from BPM 200. Thus, BPM 200 with magnetic islands 232-234 on the top surface of substrate 210 as shown in FIG. 2C is formed.

It is a problem that both of the above described methods for forming a BPM include additional fabrication steps including ion milling and resist removal processes. These additional steps worsen pattern resolution and uniformity as well as make the processes more susceptible to contamination. In addition, these steps are typically not scalable into the manufacturing process for providing higher density bit patterned media. Thus, those skilled in the art are constantly striving to provide a BPM that provides better recording density than conventional magnetic media, and is cost efficient and scalable to fabricate.

### SUMMARY

In accordance with a first embodiment, an improved magnetic media is provided. The improved magnetic media includes a substrate, a plurality of regions of resist material and magnetic material. The plurality of regions of resist material are on a top surface of the substrate and define a plurality of regions of exposed substrate on the top surface of the substrate. The magnetic material is on the plurality of regions of resist material and the plurality of regions of exposed substrate. The magnetic material on the plurality of regions of resist material forms a plurality of islands of magnetic material on a top surface of each of the plurality of regions of resist material.

In accordance with another embodiment, a method for forming magnetic media is provided. The method of forming the magnetic media includes forming a plurality of regions of resist material on a top surface of a substrate which defines a plurality of regions of exposed substrate on the top surface of the substrate between adjacent ones of the plurality of regions of resist material. The method also includes forming magnetic material on the plurality of regions of resist material and the plurality of regions of exposed substrate and depositing material over the magnetic material, the material encapsulating a portion of the magnetic material formed on the plurality of regions of exposed substrate.

### BRIEF DESCRIPTION OF THE DRAWINGS

Embodiments are described hereinafter with reference to the following drawings, in which:

FIGS. 1A-1C illustrate schematic diagrams showing a prior art fabrication method for a patterned magnetic medium in which resist patterns are transferred to a magnetic layer(s);

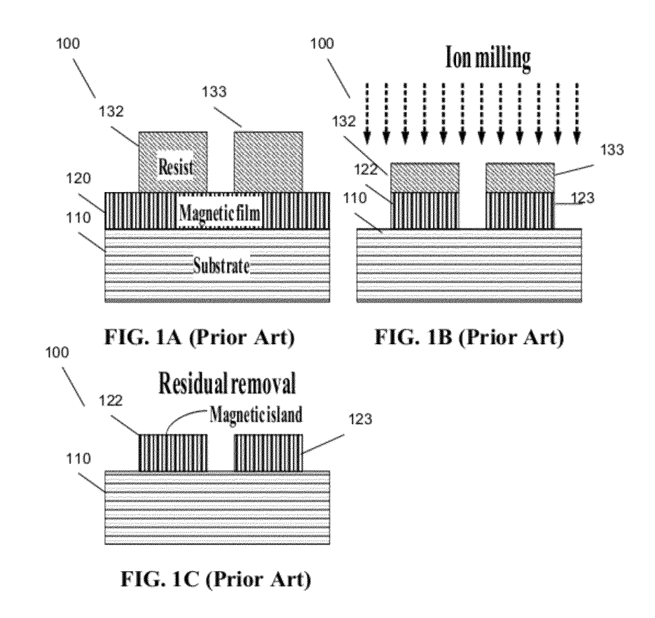

FIGS. 2A-2C illustrate schematic diagrams showing a prior art fabrication method for a patterned magnetic medium in which resist are patterned onto the medium followed by deposition of magnetic layer(s) onto the medium;

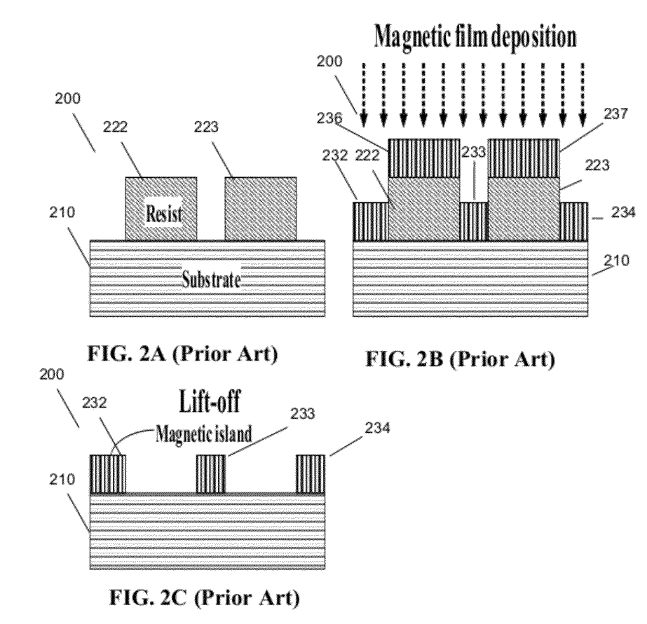

FIG. 3 illustrates a process flow chart of a process for fabricating patterned magnetic medium in accordance with a present embodiment.

FIGS. 4A-4D illustrate schematic diagrams showing the processing steps of a fabrication method in accordance with some present embodiments;

FIG. 5 illustrates a graph showing magnetic characterization of continuous [Co/Pd] multilayer magnetic film on ZEP resist;

FIG. 6 illustrates a schematic diagram showing atomic force microscopy (AFM) and magnetic force microscopy (MFM) images of patterned magnetic islands in accordance with present embodiments;

FIG. 7 illustrates a graph showing a Direct Current Demagnetization (DCD) curve for patterned magnetic islands;

FIG. 8 illustrates magnetic force microscopy (MFM) images of patterned magnetic islands having 20 nm bit pitch;

FIG. 9 illustrates magnetic force microscopy (MFM) images of patterned magnetic islands in accordance with present embodiments and with conventional ion milled media having 35 nm and 70 nm bit pitches;

FIG. 10 illustrates graphs showing a narrower switching field distribution (SFD) achieved by magnetic media in accordance with present embodiments compared to conventional ion milled magnetic media; and

FIG. 11 illustrates a schematic diagram of a magnetic media in accordance with an alternative embodiment.

### DETAILED DESCRIPTION

The present embodiment relates to a magnetic recording medium and a method for forming the magnetic recording medium. More particularly, the present embodiment relates to a magnetic recording medium having regions of a magnetic material exposed on a medium surface and the method for forming the regions on the medium surface. Throughout this document, unless otherwise indicated to the contrary, the terms “comprising”, “consisting of”, and the like, are to be construed as non-exhaustive, or in other words, as meaning “including, but not limited to”.

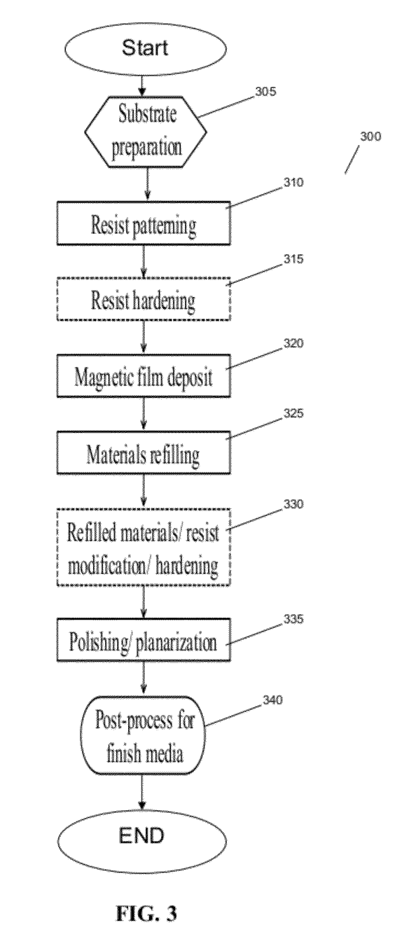

FIG. 3 illustrates a process flow diagram of process 300. Process 300 is a process for fabricating a magnetic recording medium in accordance with a present embodiment. The magnetic recording medium formed by process 300 has regions of a magnetic material exposed on the medium surface. Process 300 begins in step 305 by preparation of a substrate. The substrate may be made of materials including, but not limited to, AlTiC, SiO₂, SiN, Al₂O₃, MgO, NiP, glass, quartz, plastic, Al and other metals, and preferably has a thickness matching the design thickness of commercial recording disk media. The substrate is prepared by conventional methods and a complete description of the preparation is omitted for brevity.

Regions of resist material are then patterned onto the substrate in step 310. In accordance with some embodiments, the regions of resist material may be patterned onto the substrate by depositing a predetermined pattern of regions on the substrate. In accordance with other embodiments, a layer of resist material may be deposited on the substrate and resist material from the layer may be selectively removed to form the regions of resist material. Preferably, the resist material is deposited by spin coating. However, other processes for depositing the resist material including, but not limited to, spin coating, spray coating and dip coating may be used without departing from this invention. Furthermore, the resist patterns or regions can be generated by various kinds of lithography, including, but not limited to deep UV lithography, e-beam lithography, nanoimprint lithography, and patterns by self-assembled polymer.

The resist material used may be, but is not limited to, hydrogen silsesquioxane (HSQ), Poly methyl methacrylate (PMMA), organosilicate glass (SOG), ZEP, TGMR, maN, or other curable organic Al, Si, Mg, Li resists, where ZEP is a commercial name of a resist material available from Nippon Zeon Co. Ltd, of Tokyo, Japan, and TGMR is a commercial name of a resist material available from Tokyo Ohka Kogyo Co. Ltd, of Tokyo, Japan, and maN is a commercial name of a resist material available from Micro Resist Technology GmbH, of Berlin, Germany. Preferably, the regions of resist material are formed to a thickness between 5 nm to 500 nm. More preferably, the thickness of the regions of resist material is between 10 nm to 100 nm. The resist is deposited across the whole top surface of the substrate before lithography. Lithographic processing is used to remove portions of the resist to expose regions of the top surface of the substrate. After lithography, the regions of resist are of width and length combinations corresponding to Bit Aspect Ratios (BAR) suitable for and satisfying recording disk media of a targeted areal recording density as determined by the state of the art. Thus, the regions of resist material define regions of exposed substrate on the media between adjacent ones of the regions of resist material.

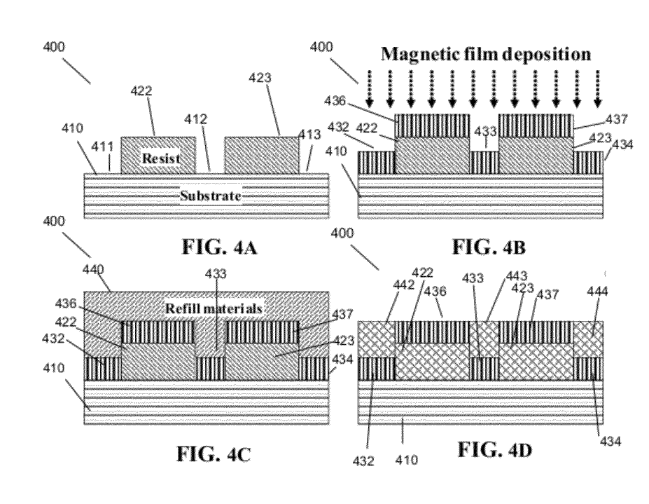

FIG. 4A illustrates media 400 after step 310 of process 300. In FIG. 4A, regions of resist material 422 and 423 are on a top surface of substrate 410. Areas of exposed substrate 411-413 are defined by regions of resist material 422-423.

Referring back to FIG. 3, process 300 continues by hardening the regions of resist material on the substrate. The need to cure or harden the resist material depends on the resist material properties and application requirements. Thus, one skilled in the art will recognize that this is an optional step that may be omitted and/or take place at another time during the process. For example in some embodiments, hydrogen silsesquioxane (HSQ) patterns defined by e-beam lithography can be further cured or hardened into SiOx/SiO₂ by curing above 200° C. In other embodiments, spin-on organosilicate glass (SOG) can be patterned and turned into glass film by heating during nanoimprint lithography.

After the depositing of the regions of resist material and or hardening of the resist material, a magnetic material is deposited, forming magnetic material on the regions of resist material deposited on the substrate to form islands of magnetic material in step 320 and on the regions of exposed substrate. In accordance with some embodiments, the magnetic material is deposited by any manufacturing deposition process which is convenient, like for example, sputter deposition. The magnetic material deposited may be a layer of Co/Pd; a layer of Co/Pt; Co/Ni multilayer film and multilayer based exchange coupled composite (ECC); a tilted media; a gradient magnetic film; or any other magnetic layer or multilayer film. The deposition of the magnetic materials may be performed by any process including, but not limited to, sputter deposition. Preferably, the magnetic film has a thickness of three to two hundred nanometers (preferably twenty to eighty nanometers), which is lower than that the thickness of the resist patterns.

FIG. 4B illustrates magnetic media 400 after the magnetic material has been deposited in accordance with step 320 of process 300. In FIG. 4B, islands of magnetic material 436 and 437 are layers of magnetic material over regions of resist material 422 and 423 respectively. Islands of magnetic material 432-434 are films of magnetic material over areas of exposed substrate 411-413.

Referring back to FIG. 3, process 300 continues after step 320 with step 325. In step 325, a refill material is deposited over the islands of magnetic material and/or exposed substrate. The refill material is deposited over the entire structure to a thickness that at least encapsulates all of the magnetic films over the regions of resist material and over the regions of exposed substrate. The refill material may be AlTiC, SiO₂, SiN, Al₂O₃, or any other non-magnetic oxide materials. In particular, the refilled materials are preferably liquid curable resists or polymers with good thermal and chemical stability after being hardening, such as HSQ and organic Al, Li, and Mg resists. In order to improve the physical and chemical properties, the refill materials can be previously modified via physical or chemical doping methods before the refilling. The refill material may also be any other resist material such as the resist material used to form the regions of resist material as described above.

In optional step 330, the refill material is hardened, such as in the case of liquid curable resist. One skilled in the art will recognize that step 315 may be performed concurrently with this step without departing from the invention. It may be preferable that the curing or hardening of resist material take place after deposition of the refill material so that the resist material can be cured or hardened together with the refill material. This depends on resist material properties and application requirements and is a design choice left to those skilled in the art. In accordance with some embodiments, the hardening of the refill material may be achieved by thermal treatment, by ultraviolet curing, or by other methods.

After the refill material is deposited and optionally hardened, planarization and/or polishing of the surface is performed in step 335. In the planarization process, refill material is removed until the magnetic material over the regions of resist material on the substrate is exposed to create islands of magnetic material in the media. The areas of magnetic material over the exposed substrate regions defined by the regions of resist material remain covered by the remaining refill material. The planarization of the deposited refill material may involve techniques used to create an essentially flat surface of the magnetic recording medium. Preferably, the planarization is achieved by polishing methods including, but not limited to, chemical mechanical polishing (CMP), lapping and plasma (or ion beam or laser) treatment. The uniformity of the polishing on the whole resulting surface should as consistent as possible.

After the refill material is planarized and/or the surface of the media is polished, any desired post processing steps may be completed. These post processing steps are optional and may include, but are not limited to, depositing protective layers and/or lubricants on the magnetic recording medium surface. In general, a carbon overcoat of one to three nanometers is deposited, followed by the application of a lubricant layer consisting of both free and bonded lubricant. Finally, a glide-burnish-certification process familiar to those skilled in the art may be used to prepare the resulting disk media.

FIG. 4D illustrates a completed media 400. In FIG. 4D, regions of resist material 422 and 423 are on a top surface of substrate 410 and define regions of exposed substrate 411-412. Encased magnetic islands of magnetic material 432-434 are on the top surface of substrate 410 in the regions of exposed substrate 411-412. Islands of exposed magnetic material 436 and 437 are on a top surface of regions of resist material 422-423. Regions of refill material surround islands of exposed magnetic material and cover the islands of magnetic material on the substrate and/or the exposed substrate. Those skilled in the art will recognize that magnetic media 400 may also include any magnetic or non-magnetic seed layer(s), underlayer(s), soft underlayer(s) (SUL(s)), interlayer(s) and additional magnetic layer(s) on top of the resist material that are applied in the post processing step 340 without departing from this invention. The medium may further include any protective and/or overcoat layers, and/or lubricants deposited on the planarized surface in post processing step 340 without departing from this invention.

As can be seen from the above description of process 300, a process in accordance with this embodiment does not require removal of resist material and does not require a pattern transfer. Thus, a simplified fabrication process with a reduced number of process steps is achieved by a process in accordance with this embodiment. In addition, there is less patterning resolution and contamination issues as these issues are normally associated with removal processes for patterning the magnetic material. As such, a process in accordance with the present embodiment achieves an improved uniformity of patterning magnetic islands and provides a scalable manufacturing process with reduced contamination which provides regions of magnetic material with improved pattern resolution and uniformity.

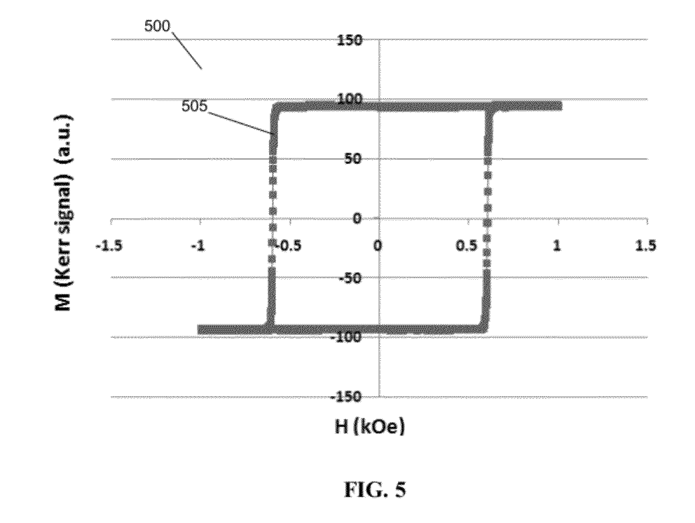

In accordance with one example embodiment, a magnetic media has high resolution ZEP resist patterns defined by e-beam lithography. FIG. 5 illustrates a graph showing magnetic characterization (magnetization versus applied magnetic field, M-H loop of a continuous [Co/Pd] multilayer magnetic film on ZEP resist) of the magnetic media of this one example embodiment. Line 505 shows good magnetic properties for the continuous [Co/Pd] multilayer magnetic film with ZEP resist. The reversal mechanism for the film is mainly domain wall motion, leading to relatively smaller coercivity Hc of approximately 580 Oe, which is typical for such film sputter-deposited at low Argon (Ar) pressure. As can be seen from line 505, there is strong exchange coupling in the continuous film as indicated by the sharp slope at coercive field. Strong exchange coupling within each individual island is desirable for bit-patterned medium (BPM).

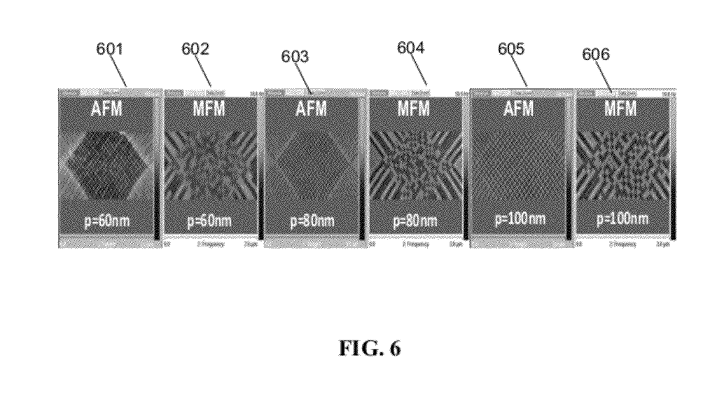

FIG. 6 illustrates atomic force microscopy (AFM) and magnetic force microscopy (MFM) images 601-606 of patterned magnetic islands (after steps 310 and 320 of process 300 shown in FIG. 3) with [Co/Pd] multilayer magnetic film on ZEP resist. As shown in images 601 and 602, good magnetic isolation is achieved for pitch (p) as small as 60 nm. In this example, trench depth is roughly equal to resist thickness of approximately 60 nm; trench depth (resist thickness) as small as approximately twenty to thirty nanometers should, however, be sufficient for good magnetic isolation and minimum magnetic signal from trench. Relatively thinner resist material is good for achieving better patterning resolution, resulting in a smaller magnetic island size. However, the height of the resist nanopatterns should be larger than that of the deposited magnetic media, and sufficiently large to achieve good magnetic isolation and high ratio of magnetic signal to noise.

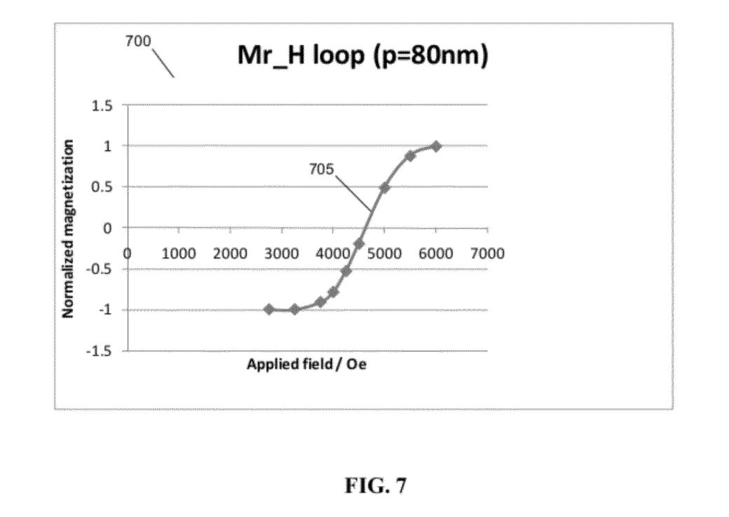

FIG. 7 illustrates graph 700 depicting a typical Direct Current Demagnetization (DCD) curve 705 for patterned magnetic islands by this method using MFM. For example, remnant coercivity Hcr of approximately 4500 Oe is measured for patterned islands with pitch, p=80 nm (island size of approximately 30-40 nm). After patterning, magnetic islands show Stoner-Wohlfarth single domain particle behavior, and thus a higher coercivity is obtained.

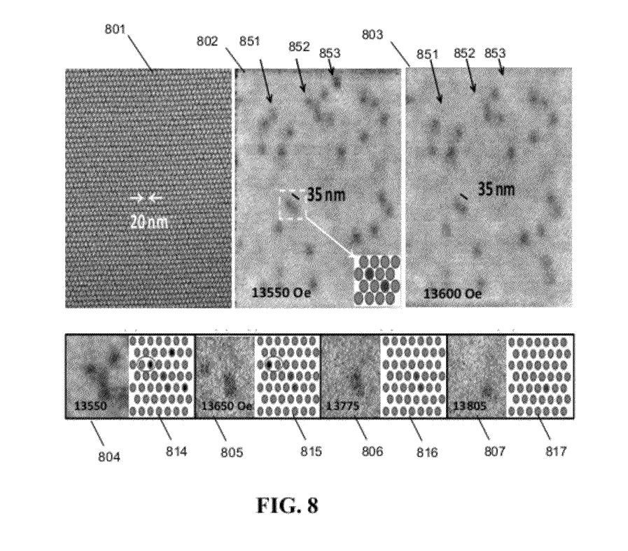

FIG. 8 illustrates atomic force microscopy (AFM) and magnetic force microscopy (MFM) images 801-807 of patterned magnetic islands having twenty nanometer bit pitch. FIG. 8 shows evidence of individual bits switching independently from neighboring bits. Image 802 shows bits 851-853 before switching and image 803 shows bits 851-853 after switching. Images 804 and 806 show isolated bits before switching and images 805 and 807 show isolated bits after switching. Representational bit layouts 814-817 illustrate the active bits in images 804-807 respectively to clearly show the independent switching of bits. Thus, a magnetic medium in accordance with this embodiment has improved resolution of individual bits over conventional patterned magnetic media.

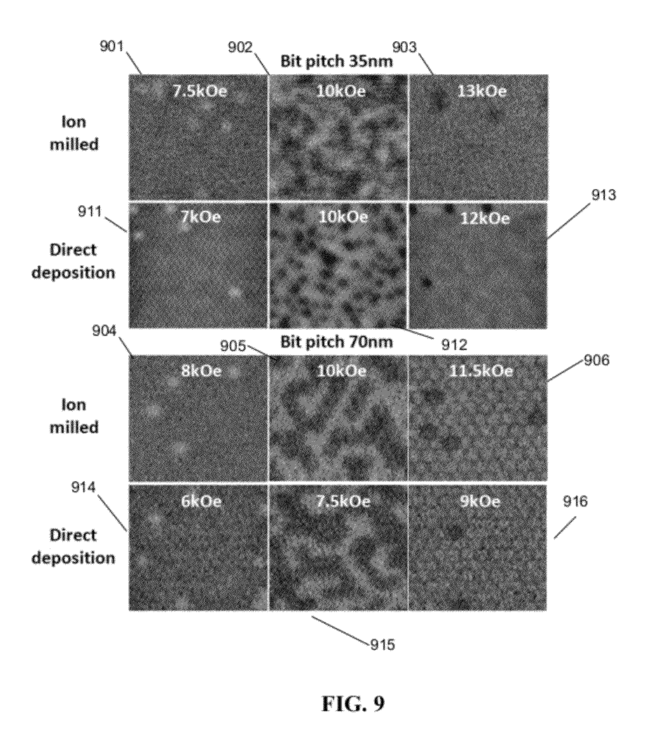

FIG. 9 illustrates magnetic force microscopy (MFM) images 901-906 of ion milled magnetic media and images of 911-916 of magnetic media in accordance with the present embodiment. Images 901-903 are images of ion milled magnetic media with a 35 nm bit pitch. Images 911-913 are images of magnetic media in accordance with this embodiment with a 35 nm bit pitch. Images 904-906 are images of ion milled media with a 70 nm bit pitch. Images 914-916 are images of magnetic media in accordance with this embodiment with a 70 nm bit pitch. As can be seen from images 901-906 and 911-916 the magnetic media in accordance with this embodiment have a narrow switching field distribution (SFD). Achievement of narrow SFDs is highly desired for magnetic media.

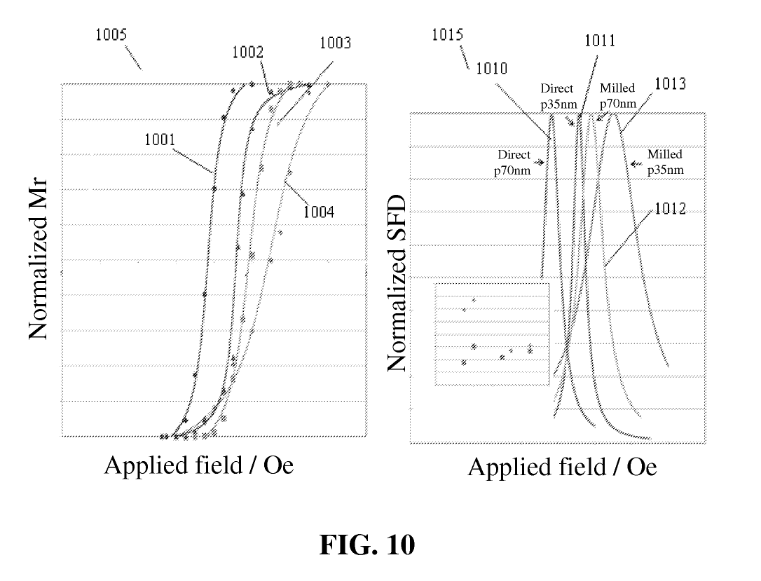

FIG. 10 illustrates graphs 1005 and 1015. Graph 1005 is a plot of experimental results of normalized remnant magnetization, Mr, versus applied field. Line 1001 shows results for media in accordance with this embodiment having a 70 nm bit pitch. Line 1002 shows results for media in accordance with this embodiment having a 35 nm bit pitch. Line 1003 shows results for an ion milled magnetic media having a 70 nm bit pitch. Line 1004 shows results for an ion milled magnetic media having a 35 nm bit pitch. Graph 1015 shows curves for normalized SFD versus applied fields for a magnetic media in accordance with this embodiment and ion milled magnetic media having different bit pitches. Curve 1010 and curve 1011 show results for media in accordance with this embodiment having a 70 nm and 35 nm bit pitch respectively. Curve 1012 and curve 1013 show results for an ion milled magnetic media having a 70 nm and 35 nm bit pitch respectively. From graphs 1005 and 1015, it is apparent that the magnetic media in accordance with this embodiment exhibits a narrower and more uniform range of SFD across the different bit pitch values than conventional ion milled media. Thus, magnetic media in accordance with this embodiment obtains narrower SFD for smaller bit pitch patterns and more uniformity of the SFD across the various bit pitches.

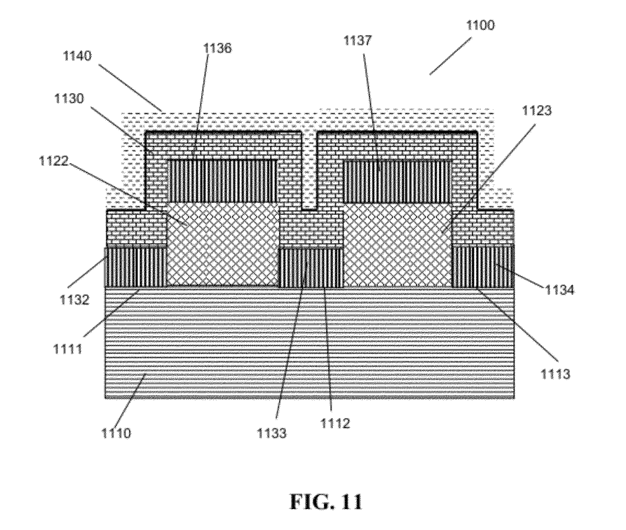

FIG. 11 illustrates a schematic diagram of magnetic media 1100 in accordance with an alternative embodiment. Magnetic media 1100 has a substrate 1110. Regions of resist material 1122 and 1123 are defined on a top surface of substrate 1110 and define regions of exposed substrate 1111-1113 in a similar manner as described above in regards to FIG. 3. Encased magnetic islands of magnetic material 1132-1134 are on the top surface of substrate 1110 in the regions of exposed substrate 1111-1113. Islands of exposed magnetic material 1136 and 1137 are on a top surface of regions of resist material 1122 and 1123. Carbon overcoat layer 1130 is deposited over the exposed surfaces including directly over magnetic material 1132-1134 on the top surface of substrate 1110 and over islands of exposed magnetic material 1136 and 1137. A layer of lubrication 1140 is then applied over carbon overcoat layer 1130. One skilled in the art will recognize that layers of other material may be added to media 1100 without departing from this embodiment.

Thus it can be seen that a magnetic media with improved pattern resolution and uniformity and an improved scalable method of manufacturing such media which reduces contamination during the manufacturing process have been provided. While various embodiments have been described and illustrated above, it should be understood that these are exemplary and are not to be considered as limiting.

What is claimed is:

1. A method for forming a magnetic media comprising:
forming a plurality of regions of resist material on a top surface of a substrate wherein a plurality of regions of exposed substrate are defined on the top surface of the substrate between adjacent ones of the plurality of regions of resist material;
forming magnetic material on the plurality of regions of resist material and the plurality of regions of exposed substrate; and
depositing material over the magnetic material wherein the material encapsulates a portion of the magnetic material formed on the plurality of regions of exposed substrate.

2. The method of claim 1 wherein the step of depositing material over the magnetic material comprises depositing refill material over the magnetic material wherein the refill material encapsulates the portion of the magnetic material formed on the plurality of regions of exposed substrate.

3. The method of claim 2 further comprising:
planarizing the refill material to expose a top surface of the magnetic material on the plurality of regions of resist material.

4. The method of claim 2 further comprising:
hardening the refill material responsive to depositing the refill material over the plurality of regions of exposed substrate and the magnetic material.

5. The method of claim 4 further comprising:
hardening the plurality of regions of resist material during the step of hardening the refill material.

6. The method of claim 2 further comprising:
depositing an overcoat layer over the magnetic material and the refill material.

7. The method of claim 6 further comprising
depositing a layer of lubrication over the overcoat layer.

8. The method of claim 1 wherein the step of depositing material over the magnetic material comprises depositing an overcoat layer over the magnetic material wherein the overcoat layer encapsulates the portion of the magnetic material formed on the plurality of regions of exposed substrate.

9. The method of claim 8 further comprising:
depositing a layer of lubrication over the overcoat layer.

10. The method of claim 1 wherein the step of forming the plurality of regions of resist material comprises depositing a predetermined pattern of resist material on the top surface of the substrate.

11. The method of claim 1 wherein the step of forming the plurality of regions of resist material comprises:
depositing a layer of resist material on the top surface of the substrate; and
selectively removing a portion of the layer of resist material from the top layer of the substrate to form the plurality of regions of resist material.

12. The method of claim 1 wherein the step of forming the magnetic material comprises depositing the magnetic material on the plurality of regions of resist material and the plurality of regions of exposed substrate in accordance with a manufacturing deposition process.

13. The method of claim 1 wherein the step of forming the magnetic material comprises forming a magnetic film on the plurality of regions of resist material and the plurality of regions of exposed substrate.

14. The method of claim 1 wherein the step of forming the plurality of regions of resist material comprises forming the plurality of regions of resist material to a thickness of about 5 nm to about 500 nm.

15. The method of claim 1 wherein the step of forming the plurality of regions of resist material comprises forming the plurality of regions of resist material to a thickness of about 10 nm to about 100 nm.

16. The method of claim 1 wherein the step of forming the plurality of regions of resist material comprises forming the plurality of regions of resist material to a first thickness, and wherein the step of forming the magnetic material comprises forming the magnetic material to a second thickness, and wherein the second thickness is less than the first thickness.

17. A magnetic media comprising:
a substrate;
a plurality of regions of resist material on a top surface of the substrate defining a plurality of regions of exposed substrate on the top surface of the substrate; and
magnetic material on the plurality of regions of resist material and the plurality of regions of exposed substrate, wherein the magnetic material on the plurality of regions of resist material forms a plurality of islands of magnetic material on a top surface of each of the plurality of regions of resist material.

18. The magnetic media of claim 17 wherein the plurality of regions of resist material comprise a material selected from the group consisting of ZEP, hydrogen silsesquioxane, Poly (methyl methacrylate), TGMR, maN, organosilicate glass, curable organic aluminum resist, curable organic magnesium resist, and curable organic lithium resist.

19. The magnetic media of claim 17 wherein the plurality of regions of resist material are of a thickness between about 5 nm and about 500 nm.

20. The magnetic media of claim 17 wherein the plurality of regions of resist material are of a thickness between about 10 nm and about 100 nm.

21. The magnetic media of claim 17 wherein the plurality of islands of magnetic material comprise a material selected from the group consisting of Co/Pd, Co/Pt, Co/Ni, and exchange coupled composite (ECC).

22. The magnetic media of claim 17 wherein the plurality of islands of magnetic material comprise one or more layers selected from the group consisting of magnetic seed layers, non-magnetic seed layers, underlayers, soft underlayers, interlayers, and additional magnetic layers.

23. The magnetic media of claim 17 further comprising:
refill material surrounding the plurality of islands of magnetic material and the plurality of resist material and over the magnetic material over the plurality of regions of exposed substrate, thereby encapsulating the magnetic material over the plurality of regions of exposed substrate.

24. The magnetic media of claim 23 wherein the refill material comprises a material selected from a group consisting of SiO₂, SiN, Al₂O₃, HSQ, other non-magnetic oxide material, other curable resists, and other curable polymers.

25. The magnetic media of claim 23 further comprising:
an overcoat layer over the plurality of islands of magnetic material and the refill material surrounding the plurality of islands of magnetic material.

26. The magnetic media of claim 17 further comprising:
an overcoat layer over the plurality of islands of magnetic material and the plurality of resist material and over the magnetic material over the plurality of regions of exposed substrate.

27. The magnetic media of claim 26 wherein the overcoat layer is directly over the plurality of islands of magnetic material and the plurality of resist material and directly over the magnetic material over the plurality of regions of exposed substrate, thereby encapsulating the magnetic material over the plurality of regions of exposed substrate.

28. The magnetic media of claim 25 further comprising:
a layer of lubricant over the overcoat layer over the plurality of islands of magnetic material and the refill material.

29. The magnetic media of claim 26 further comprising:
a layer of lubricant over the plurality of islands of magnetic material and the plurality of regions of exposed substrate.
